(19) United States
(12) Patent Application Publication
(10) Pub. No.: US 2026/0340361 A1
(43) Pub. Date: Oct. 29, 2026

(54) MANAGING VARIABILITY OF GENERATIVE ARTIFICIAL INTELLIGENCE (AI) MODEL OUTPUTS

(71) Applicant: Dell Products L.P., Round Rock, TX (US)

(72) Inventors: OFIR EZRIELEV, Be'er Sheva (IL); HANNA YEHUDA, Acton, MA (US); ANNE-MARIE MCREYNOLDS, San Jose, CA (US)

(21) Appl. No.: 19/191,792

(22) Filed: Apr. 28, 2025

(51) Int. Cl. G06N 3/0475; G06N 3/045

(52) U.S. Cl. CPC G06N 3/0475; G06N 3/045

(57) ABSTRACT

Methods and systems for providing computer-implemented services using generative AI models are disclosed. To do so, a prompt may be obtained for a first generative AI model of the generative AI models. The prompt may be iteratively perturbated to obtain perturbated prompts. The perturbated prompts and the first generative AI model may be used to obtain perturbated outputs. An output alignment process may be performed, using the perturbated outputs, to obtain differences between portions of the perturbated outputs. Degrees of variability may be obtained, using the differences, for the portions of the perturbated outputs. Computer-implemented services may be provided to a downstream consumer using at least the degrees of variability.

### FIELD

Embodiments disclosed herein relate generally to providing computer-implemented services using generative artificial intelligence (AI) models. More particularly, embodiments disclosed herein relate to managing variability of generative AI model outputs.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIG. 2A shows a flow diagram illustrating data flows in accordance with an embodiment.

FIGS. 2B-2E show examples of a graphical user interface (GUI) and an output alignment process in accordance with an embodiment.

FIG. 3 shows a flow diagram illustrating a method for providing computer-implemented services using generative AI models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using generative AI models. The generative AI models may include large language models (LLMs) that may generate outputs when provided with prompts. The outputs may be used, at least in part, to provide the computer-implemented services. For example, the outputs may be provided to a downstream consumer and the downstream consumer may use the outputs to make decisions.

However, a usefulness of the outputs to the downstream consumer may be reduced if the downstream consumer does not know why a particular output was generated. For example, a downstream consumer (e.g., a client, a customer) may desire to use an output to manage a computer system. In addition, the computer system managed by the client may store private medical information, private financial information, and/or other data protected by various regulatory standards (e.g., general data protection regulation (GDPR), health insurance portability and accountability act (HIPPA)).

If the downstream consumer does not understand why a particular output was generated, the downstream consumer may be unwilling to use the output and/or make decisions based on the output. For example, portions of data used as ingest for the generative AI model may have different degrees of influence on the output and, therefore, modifications to the ingest data may yield different outcomes. If these outcomes have a high degree of variability (e.g., if the stability of a portion of the output is low relative to other portions of the output), downstream consumers may not trust the outputs.

To provide information to the downstream consumer regarding stability of portions of an output, degrees of variability for portions of outputs may be provided to downstream consumers along with the outputs. Degrees of variability may provide insight into a generative AI model's decision making processes and may allow the downstream consumer to make adjustments to the prompt and/or the available data sources to alter a particular portion of the output.

To obtain the degrees of variability, a prompt for a generative AI model may be iteratively perturbated (e.g., information elements of the prompt may be removed or replaced with replacement information elements) to obtain perturbated prompts. The perturbated prompts and the generative AI model may be used to generate perturbated outputs (outputs generated by the generative AI model using at least the perturbated prompts as ingest). An output alignment process may be performed, using the perturbated outputs, to obtain differences between portions of the perturbated outputs. The differences may be used to obtain the degrees of variability (e.g., for the portions of the perturbated outputs) and the degrees of variability may be used to provide computer-implemented services to downstream consumers.

Performing the output alignment process may include: (i) obtaining a first sequence of tokens (e.g., generated by the generative AI model) for a first perturbated output of the perturbated outputs, (ii) aligning the first sequence to other sequences of tokens corresponding to other perturbated outputs of the perturbated outputs (e.g., shifting the sequences using a mathematical formula to increase alignment between the sequences) to obtain a first set of aligned sequences, (iii) comparing each token of the first sequence to corresponding tokens of the first set of the aligned sequences to generate a sub-set of the differences corresponding to the first perturbated output, and/or (iv) other methods.

Thus, embodiments disclosed herein may provide an improved method for providing computer-implemented services using generative AI models. To provide the computer-implemented services as desired by downstream consumers, information related to degrees of variability of portions of outputs may be provided to the downstream consumers along with the outputs generated by the generative AI model. The degrees of variability may indicate a stability of the portions of outputs thereby increasing a usefulness of the outputs to the downstream consumer.

In an embodiment, a method for providing computer-implemented services using generative AI models is provided. The method may include: obtaining a prompt for a first generative AI model of the generative AI models; iteratively perturbating the prompt to obtain perturbated prompts; using the first generative AI model and the perturbated prompts to obtain perturbated outputs; performing, using the perturbated outputs, an output alignment process to obtain differences between portions of the perturbated outputs; obtaining, using the differences, degrees of variability for the portions of the perturbated outputs; and providing computer-implemented services to a downstream consumer using at least the degrees of variability.

Performing the output alignment process may include: for a first perturbated output of the perturbated outputs: obtaining a first sequence of tokens corresponding to the first perturbated output; aligning the first sequence of the tokens to other sequences of tokens corresponding to other perturbated outputs of the perturbated outputs to obtain a first set of aligned sequences; and for each token of the first sequence of the tokens, comparing the token to corresponding tokens of the first set of the aligned sequences to generate a sub-set of the differences corresponding to the tokens of the first sequence of the tokens.

Aligning the first sequence of the tokens may include: shifting, using a mathematical formulation, the other sequences relative to the first sequence to increase alignment between tokens of the first sequence and tokens of the other sequences.

A degree of variability of the degrees of variability may be based on at least one measure of variability selected from a list of types of measures of variability consisting of: a range of differences of the sub-set of the differences corresponding to the first token, a standard deviation for the differences, and a variance for the differences.

The portions of the perturbated outputs may include tokens generated by the first generative AI model.

A token of the tokens may include at least one type of token selected from a list of types of tokens consisting of: a word; a letter; a punctuation mark; and a phrase.

Providing the computer-implemented services may include: populating, using at least a first perturbated output of the perturbated outputs and the degrees of variability corresponding to tokens of the first perturbated output, a graphical user interface (GUI) to obtain a populated GUI, the populated GUI being viewable by the downstream consumer.

The GUI may display, to the downstream consumer, portions of a selected perturbated output of the perturbated outputs and the portions of the selected perturbated output may be color-coded based on the degrees of variability for the portions of the perturbated output.

Iteratively perturbating the prompt may include: obtaining first tokens of the prompt; and performing at least one action selected from a list of actions consisting of: removing a first token of the first tokens to obtain a first perturbated prompt of the perturbated prompts; and replacing the first token with a replacement token to obtain the first perturbated prompt.

The first generative AI model may be a large language model (LLM).

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

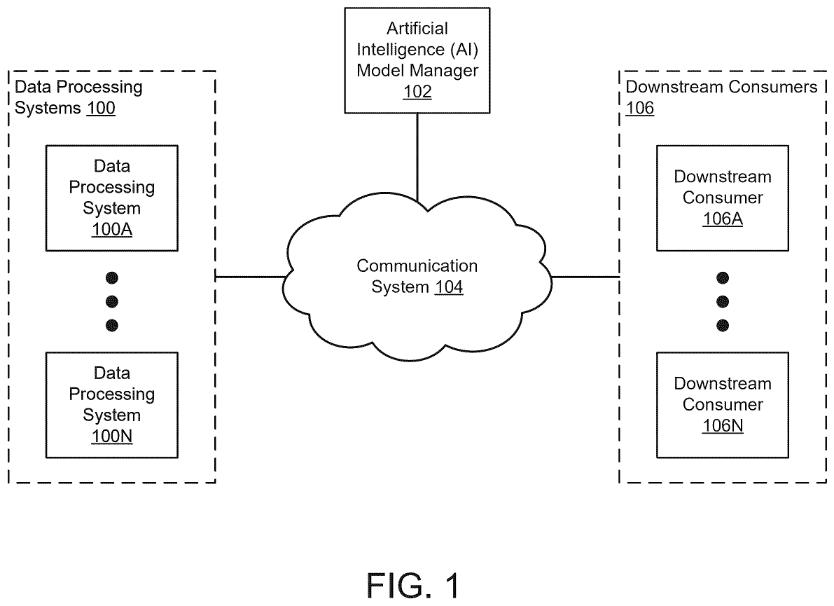

Turning to FIG. 1, a block diagram illustrating a system in accordance with an embodiment is shown. The system shown in FIG. 1 may provide for management of data processing systems that may provide, at least in part, computer-implemented services (e.g., to users of the system and/or devices operably connected to the system).

The computer-implemented services may include any type and quantity of computer-implemented services. The computer-implemented services may include, for example, database services, data processing services, electronic communication services, inference generation services, and/or any other services that may be provided using one or more computing devices. The computer-implemented services may be provided by, for example, data processing systems 100, AI model manager 102, downstream consumers 106, and/or any other type of devices (not shown in FIG. 1). Other types of computer-implemented services may be provided by the system shown in FIG. 1 without departing from embodiments disclosed herein.

The computer-implemented services may be provided, at least in part, using generative AI models and/or outputs obtained using the generative AI models. To do so, data processing systems 100 and/or AI model manager 102 may host any number of generative AI models.

To obtain the outputs, the generative AI models may be trained, using training data, to generate the outputs when provided with prompts (e.g., ingest data). The generative AI models may include large language models (LLMs) and, therefore, the outputs may include new instances of data created by the generative AI models based on learned associations from and/or an understanding of the training data. For example, the generative AI models may be trained using unstructured data, such as stories, essays, audio transcription, video description, and/or other types of human interpretable text, to generate outputs of the same. The outputs may be provided to downstream consumers 106 (e.g., client devices, data processing systems that manage computer systems and/or production systems) as part of providing the computer-implemented services.

However, the outputs may be provided to downstream consumers 106 as part of: (i) customer service requests (e.g., troubleshooting computer systems), (ii) data management processes (e.g., healthcare data, financial data), (iii) production system management processes (e.g., industrial applications), and/or (iv) other processes. The outputs, therefore, may be desired (e.g., by downstream consumers 106) to meet certain expectations. For example, downstream consumers 106 may expect the generative AI model and the outputs to comply with data privacy regulations (e.g., GDPR, HIPPA), may desire to mitigate unintended bias in outputs (e.g., when using the responses to make decisions based on financial data of consumers), and/or may otherwise wish to understand, audit, and/or modify operation of the generative AI models.

For example, information content of outputs generated by downstream consumers may have high degrees of variability when ingest data for the generative AI model is modified (e.g., different phrasing of a prompt, removal of portions of the prompt). If an output is considered unstable (e.g., portions of the output vary over a wide range with modifications to portions of the prompt), downstream consumers 106 may not trust the outputs. If downstream consumers 106 are unable to determine whether the generative AI models and/or the outputs meet their expectations, a usefulness of the outputs to downstream consumers 106 may be reduced.

In general, embodiments disclosed herein may provide methods, systems, and/or devices for providing information related to degrees of variability for portions of outputs generated by generative AI models along with the outputs. The information related to the degrees of variability may indicate (e.g., in human-interpretable text) stability of portions of the output, which may increase a usefulness of the outputs to downstream consumers 106.

To do so, a prompt for a first generative AI model may be obtained. The prompt may be iteratively perturbated (e.g., information elements of the prompt may be removed, information elements of the prompt may be replaced with replacement information elements) to obtain perturbated prompts. The perturbated prompts and a first generative AI model may be used to generate perturbated outputs. For example, the perturbated prompts may be fed into the first generative AI model and the perturbated outputs may be obtained as output from the first generative AI model.

An alignment process may be performed, using the perturbated outputs, to obtain differences between portions of the perturbated outputs. Performing the alignment process may include: (i) obtaining a first sequence of tokens corresponding to a first perturbated output of the perturbated outputs, (ii) aligning the first sequence of the tokens to other sequences of tokens corresponding to the other perturbated outputs of the perturbated outputs to obtain a first set of aligned sequences, (iii) comparing each token of the first sequence to corresponding tokens of the first set of the aligned sequences to generate a sub-set of the differences corresponding to the first sequence of the tokens (e.g., and, therefore, corresponding to the first perturbated output), and/or (iv) other methods.

The differences (e.g., the first sub-set and other sub-sets of the differences generated for the other perturbated outputs of the perturbated outputs using methods similar to those described with respect to generating the first sub-set) may be used to obtain degrees of variability for the portions of the perturbated outputs. The degrees of variability may be used to provide computer-implemented services to downstream consumers 106.

Thus, embodiments disclosed herein may improve processes of explaining outputs generated by generative AI models to downstream consumers of the outputs. By iteratively perturbating prompts and comparing perturbated outputs generated by the perturbated prompts, degrees of variability of portions of the output may be obtained and, therefore, transparency of decision-making by the generative AI model may be increased.

To provide the above noted functionality, the system of FIG. 1 may include data processing systems 100, AI model manager 102, downstream consumers 106, and communication system 104. Each of these components is discussed below.

Data processing systems 100 may provide all, or a portion of, the computer-implemented services. Data processing systems 100 may include any number of data processing systems (e.g., 100A-100N) that may provide output generation services to downstream consumers 106. For example, a downstream consumer (e.g., 106A) may subscribe to output generation services provided by data processing system 100A and downstream consumer 106A may provide prompts (e.g., from clients, from owners of downstream consumer 106A, from employees of a company that owns downstream consumer 106A) to data processing system 100A as part of the subscribed services.

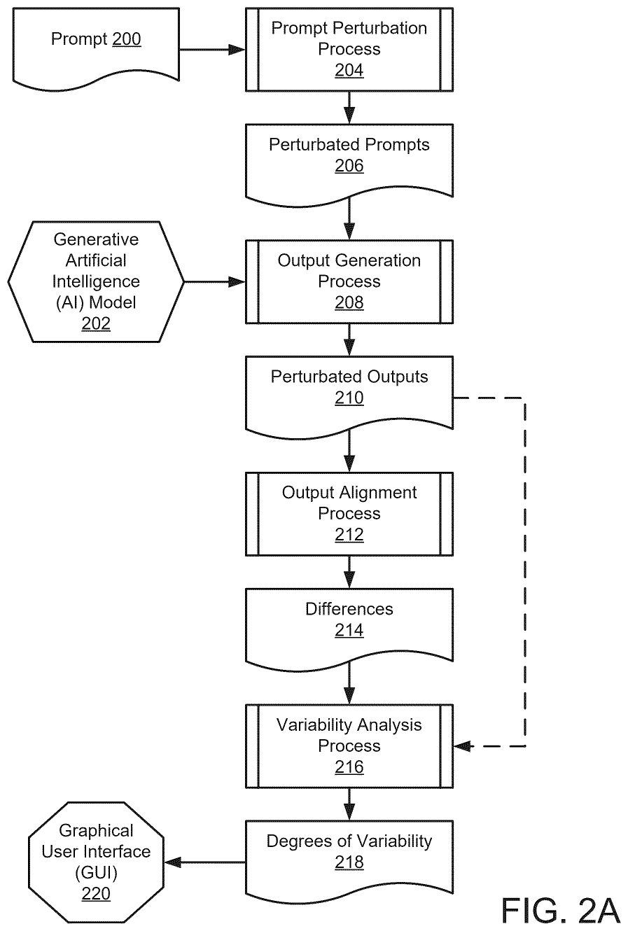

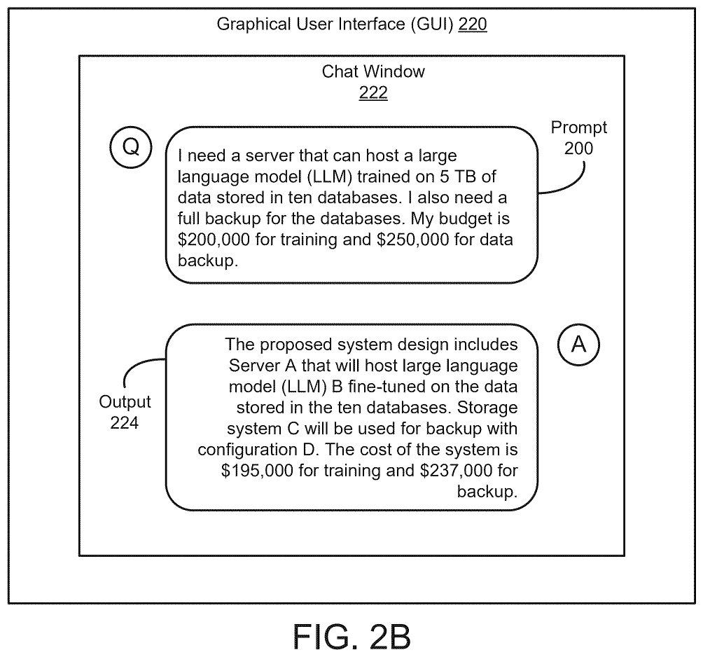

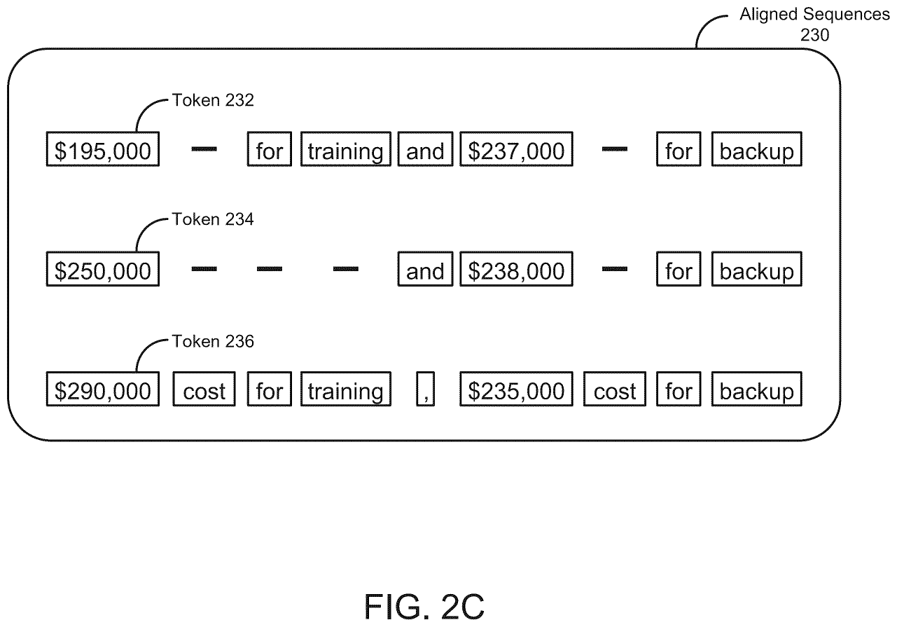

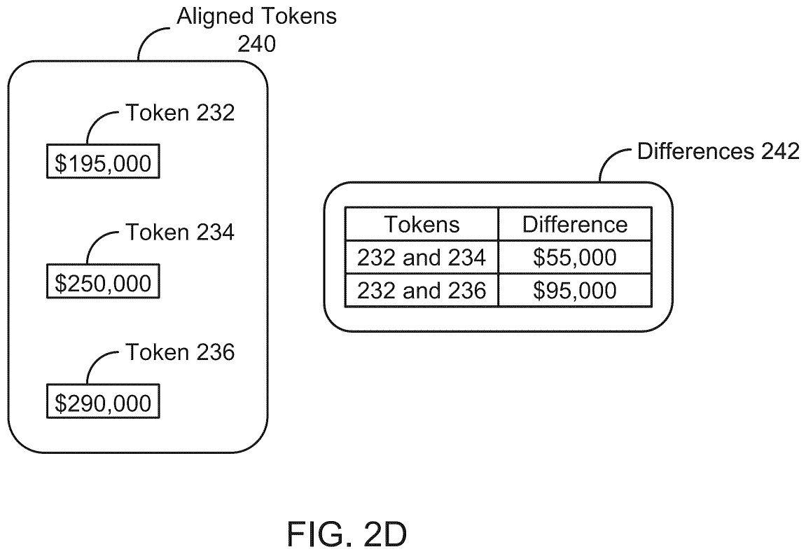

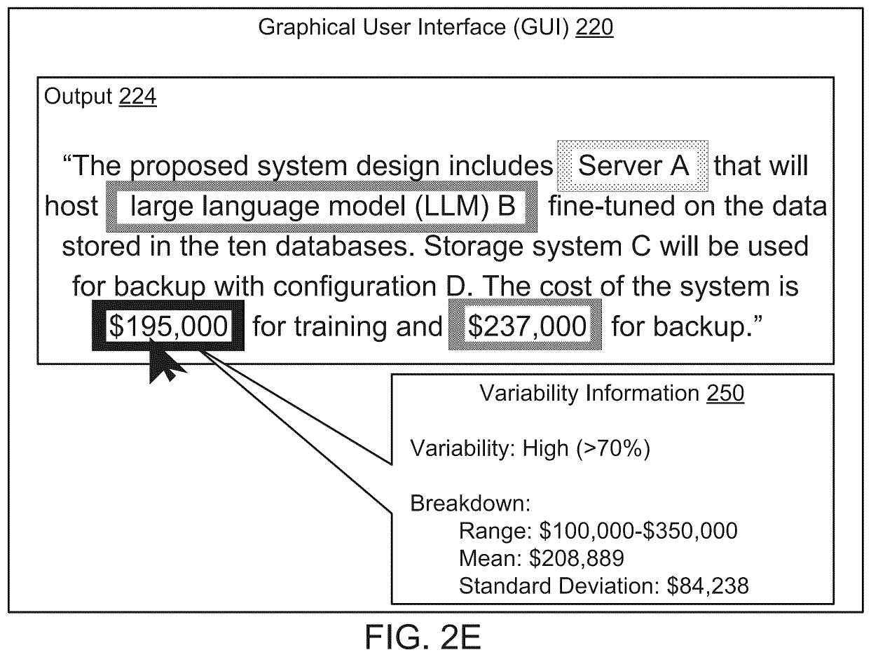

To provide computer-implemented services, data processing systems 100 may: (i) obtain prompts for generative AI models (e.g., hosted and/or operated by data processing systems 100), (ii) iteratively perturbate the prompt to obtain perturbated prompts, (iii) feed the perturbated prompts into a generative AI model to obtain perturbated outputs, (iv) perform output alignment processes using the perturbated outputs to obtain differences between portions of the perturbated outputs, (v) obtain, using the differences, degrees of variability for the portions of the perturbated outputs, (vi) provide computer-implemented services to downstream consumers 106 using at least the outputs and the degrees of variability, and/or (vii) perform other actions. Refer to FIG. 2A for additional details regarding performing output alignment processes. Refer to FIG. 2C for an example of a set of aligned sequences.

AI model manager 102 may manage any number of AI models. For example, AI model manager 102 may: (i) obtain training data for AI models, (ii) train any number of AI models to obtain trained AI models, (iii) deploy trained AI models to other entities (e.g., data processing systems 100), (iv) update and/or modify trained AI models (e.g., fine-tune trained AI models based on additional training and/or production data), and/or (v) provide other AI model management services.

For example, AI model manager 102 may cooperatively provide at least a portion of the computer-implemented services to data processing systems 100 by: (i) obtaining training data from downstream consumers 106, (ii) training one or more AI models (e.g., generative AI models) using at least the training data obtained from downstream consumers 106 to obtain one or more trained AI models, (iii) deploying the one or more trained AI models to data processing systems 100 for use in providing output generation services for downstream consumers 106, and/or (iv) performing other actions.

Downstream consumers 106 may provide and/or consume all, or a portion of, the computer-implemented services. Downstream consumers 106 may include any number of downstream consumers (e.g., 106A-106N) and may include, for example, businesses, individuals, and/or devices (e.g., data processing systems) that may obtain outputs and/or other information based on the outputs as part of receiving the computer-implemented services.

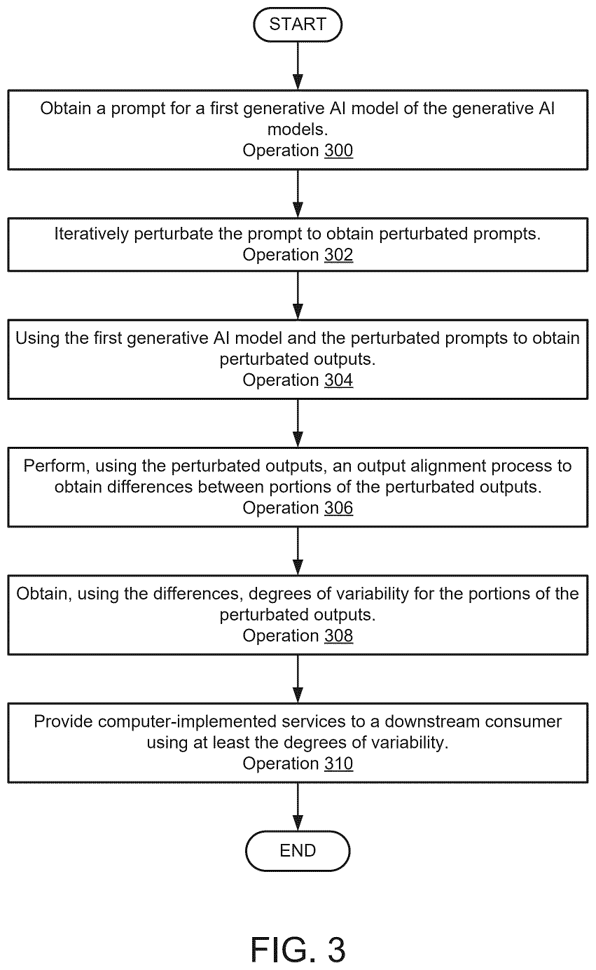

When providing their functionality, any of (and/or components thereof) data processing systems 100, AI model manager 102, and/or downstream consumers 106 may perform all, or a portion, of the actions and methods illustrated in FIGS. 2A-3.

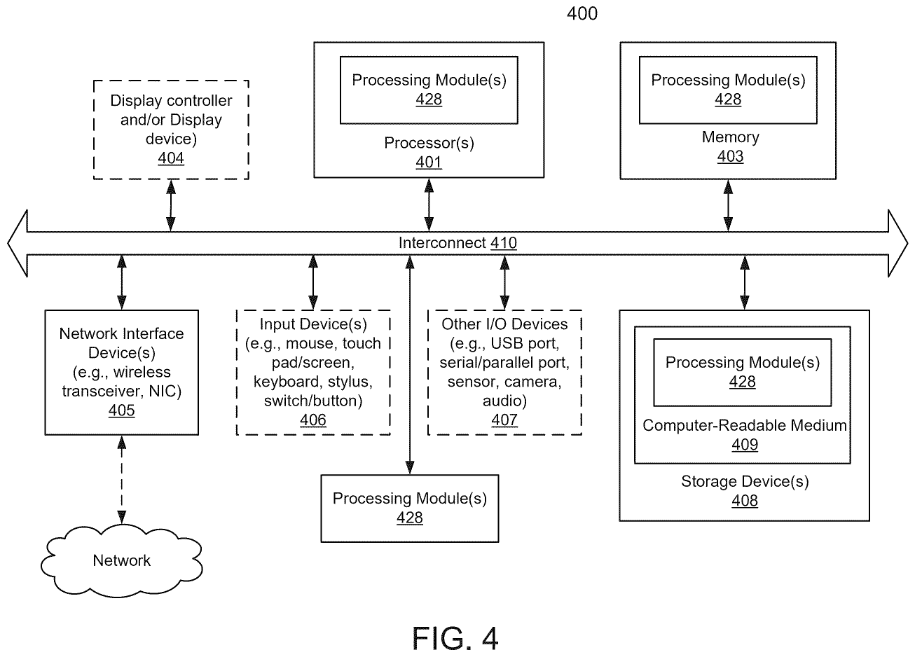

Any of (and/or components thereof) data processing systems 100, AI model manager 102, and downstream consumers 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

Communication system 104 may allow any of data processing systems 100, AI model manager 102, and downstream consumers 106 to communicate with one another (and/or with other devices not illustrated in FIG. 1). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to AI model manager 102 and downstream consumers 106 via the Internet. Data processing systems 100, AI model manager 102, downstream consumers 106, and/or communication system 104 may be adapted to perform one or more protocols for communicating via communication system 104.

While illustrated in FIG. 1 as including a limited number of specific components, a system in accordance with an embodiment may include fewer, additional, and/or different components than those illustrated therein.

While providing their functionality, any of data processing systems 100, AI model manager 102, and/or downstream consumers 106 may provide all or a portion of the methods shown in FIGS. 2A-3.

To further clarify embodiments disclosed herein, a data flow diagram in accordance with an embodiment is shown in FIG. 2A. In this diagram, flows of data and processing of data are illustrated using different sets of shapes. A first set of shapes (e.g., 200, 206, etc.) is used to represent data structures, a second set of shapes (e.g., 204, 208 etc.) is used to represent processes performed using and/or that generate data, a third set of shapes (e.g., 202) is used to represent generative AI models, and/or other types of models, and a fourth set of shapes (e.g., 220) is used to represent graphical user interfaces (GUIs).

Turning to FIG. 2A, a data flow diagram in accordance with an embodiment is shown. The data flow diagram may illustrate data used in and data processing performed in obtaining degrees of variability for portions of generative AI model outputs.

To obtain the degrees of variability, at least prompt perturbation process 204, output generation process 208, output alignment process 212, and variability analysis process 216 may be performed.

During prompt perturbation process 204, prompt 200 may be iteratively perturbated to obtain perturbated prompts 206. Prompt 200 may be intended to elicit an output from a generative AI model (e.g., generative AI model 202) that includes information content desired by downstream consumer 106A (e.g., prompt 200 may be obtained from downstream consumer 106A, refer to FIG. 1 for details regarding downstream consumer 106A). Prompt 200, for example, may include human-interpretable text and may include a question. For example, prompt 200 may include: (i) a request from a user for help assessing a malfunction of a computer system, (ii) a request from a customer for a product recommendation, (iii) a request from an employee of a business for a recommendation regarding a financial product (e.g., whether to extend a line of credit to a customer), and/or (iv) other requests. Refer to FIG. 2B for an example of prompt 200.

During prompt perturbation process 204, a first information element (e.g., a first token) of prompt 200 may be modified (e.g., removed, replaced with a replacement information element) to obtain a first perturbated prompt. The first information element may be selected based on: (i) a policy, (ii) an information element replacement schema, (iii) user feedback (e.g., a client may select the information element via a GUI), and/or (iv) via other methods.

The information elements of prompt 200 may include any item, object, or entity in prompt 200 and the information elements may be identified via any algorithm, machine learning model, and/or rule set for natural language processing to extract information from text. Information elements may be extracted from other types of data modalities (e.g., images, audio, video) via object recognition algorithms or models. Information elements may be obtained via other methods without departing from embodiments disclosed herein.

For example, prompt 200 may include the following text: “My computer is not working. It keeps re-starting and overheating. I have computer A and I use operating system B, monitor C, keyboard D, and mouse E. How do I fix it?” The first information elements extracted from prompt 200 may, therefore, include: (i) computer A, (ii) operating system B, (iii) monitor C, (iv) keyboard D, and (v) mouse E.

The information elements may be stored as a list, as a graphical representation of the information elements, as human-interpretable text that summarizes the information elements, and/or in other formats. The information elements (e.g., the human-interpretable text, the graphical representation, the list) may be published to a client portal and may be accessible by a downstream consumer via a graphical user interface (GUI).

Continuing with the above example, information elements of prompt 200 may be iteratively removed (e.g., one information element may be removed at a time) to generate any number of perturbated prompts (e.g., 206). For example, the information element “operating system B” may be removed from prompt 200 to obtain a perturbated prompt that includes the following text: “My computer is not working. It keeps re-starting and overheating. I have computer A and I use monitor C, keyboard D, and mouse E. How do I fix it?”

Prompt 200 may also be modified, for example, by replacing the first information element with a replacement information element (e.g., provided by a user via a GUI, obtained using a retrieval augmented generation (RAG) process and any number of data sources) to obtain the perturbated prompt. For example, the information element “monitor C” may be replaced with a replacement information element “monitor K” to generate a perturbated prompt that includes the following text: “My computer is not working. It keeps re-starting and overheating. I have computer A and I use operating system B, monitor K, keyboard D, and mouse E. How do I fix it?”

Perturbated prompts 206 and generative AI model 202 may be used to perform output generation process 208. For example, generative AI model 202 may be an LLM (e.g., a neural network inference model) trained to generate language, understand language, and/or otherwise process requests related to languages. Generative AI model 202 may have been previously trained using training data and any training process (e.g., a global optimization process using gradient descent), the training data indicating goals for outputs generated by generative AI model 202 (e.g., outputs). Parameters of generative AI model 202 may be selected using an optimization process (e.g., an objective function may be defined in terms of the training data and outputs generated by generative AI model 202, and a global optimization method such as gradient descent may be used to identify parameters that most faithfully reproduce the trends in the training data). Once the parameters of generative AI model 202 are set, then generative AI model 202 may be used to generate outputs (e.g., responses) based on input data (e.g., prompts). Generative AI model 202 may be trained using other methods without departing from embodiments disclosed herein.

During output generation process 208, perturbated prompts 206 may be provided as ingest to generative AI model 202 and perturbated outputs 210 may be obtained as outputs from generative AI model 202. Output generation process 208 may also include performing retrieval-augmented generation (RAG) processes to augment perturbated prompts 206 with data sources relevant to each of perturbated prompts 206.

Each perturbated output of perturbated outputs 210 may include tokens (e.g., generated by generative AI model 202 during output generation process 208. The tokens may include: (i) words, (ii) letters, (iii) punctuation marks, (iv) phrases, and/or (v) other components of perturbated outputs 210. For example, a first perturbated output may include the following text: “We recommend re-installing driver F and disconnecting and re-connecting all Bluetooth devices.” Tokens of the first perturbated output, therefore, may include: (i) “we,” (ii) “recommend,” (iii) “re-installing,” (iv) “driver F,” (v) “and,” (vi) “disconnecting,” (vii) “re-connecting,” (viii) “all,” and (ix) “Bluetooth devices.” Tokens may include other tokens (e.g., “Bluetooth” and “devices” may be separate tokens, “.” may be an additional token).

Perturbated outputs 210 may be used to perform output alignment process 212. During output alignment process 212, a first sequence of tokens corresponding to a first perturbated output of perturbated outputs 210 may be obtained. Other sequences of tokens corresponding to other perturbated outputs of perturbated outputs 210 may be aligned relative to the first sequence of tokens using a mathematical formulation (e.g., the other sequences may be shifted to increase, as much as possible, alignment of tokens of the other sequences with tokens of the first sequence). Refer to FIG. 2C for an example of a set of aligned sequences.

During output alignment process 212, after obtaining the aligned set of sequences, differences 214 may be obtained. Differences of differences 214 may include, for example, differences between corresponding (e.g., aligned) tokens of a set of aligned sequences. A first sub-set of differences 214 may include differences between a first token of the first sequence and a corresponding token of each of the other sequences.

Differences 214 may be obtained using any similarity measure (e.g., differences between numerical values, Manhattan distance, cosine similarity, radial basis function kernel) between tokens in the aligned sequences.

At least differences 214 may be used to perform variability analysis process 216 to obtain degrees of variability 218. During variability analysis process 216, values of differences 214 may be used to generate any number of aggregated statistics related to variability of tokens in each of perturbated outputs 210. For example, if differences 214 includes a set of Manhattan distances between a first token and corresponding tokens of other sequences in an aligned set of sequences corresponding to a first perturbated output of perturbated outputs 210, variability analysis process 216 may include calculating: (i) a range of the Manhattan distances, (ii) a standard deviation for the Manhattan distances, (iii) a variance for the Manhattan distances, and/or (iv) other indications of variability based on the Manhattan distances. The range, standard deviation, and variance may be included in degrees of variability 218.

A dotted line is shown in FIG. 2A between perturbated outputs 210 and variability analysis process 216 to indicate that values of tokens of perturbated outputs 210 may also be used to generate degrees of variability 218. For example, if a set of aligned tokens includes numerical values, variability analysis process 216 may include calculating degrees of variability based on the numerical values (e.g., a range for the numerical values, a standard deviation of the numerical values) with or without calculating differences between the numerical values. In addition, at least a portion of differences 214 may be included in degrees of variability 218.

The processes of obtaining a set of aligned sequences, obtaining differences based on the set of aligned sequences, and obtaining degrees of variability based on at least the differences may be repeated for each of perturbated outputs 210.

Graphical user interface (GUI) 220 may be populated using at least degrees of variability 218 to obtain a populated GUI. GUI 220 may be accessible by downstream consumers (e.g., via a website) and may include any number of pop-up interfaces, chat windows, buttons, graphics, and/or other elements through which information may be displayed to a viewer (e.g., a downstream consumer) and/or through which the viewer may interact. Refer to FIGS. 2B-2E for examples of information that may be displayed to a user via GUI 220.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, by implementing the data flow shown in FIG. 2A, a system in accordance with embodiments disclosed herein may be used to generate: (i) outputs from generative AI models based on prompts and (ii) degrees of variability for portions of the outputs. By iteratively perturbating prompt 200 and generating perturbated outputs based on the perturbated prompts, the degrees of variability may be generated to indicate stability of the portions of the perturbated outputs. Consequently, a reliability and/or usefulness of outputs may be increased for the downstream consumer.

Turning to FIG. 2B, an example of prompt 200 and output 224 (e.g., one of perturbated outputs 210 described in FIG. 2A) are shown. A customer (e.g., downstream consumer 106A described in FIG. 2A) may access graphical user interface (GUI) 220 through which the customer may receive assistance with a product recommendation request. A customer may open chat window 222 as part of functionality of GUI 220 and may enter prompt 200 into the chat window. Prompt 200 may include the following text: “I need a server that can host a large language model (LLM) trained on 5 terabytes (TB) data stored in ten databases. I also need a full backup for the databases. My budget is $200,000 for training and $250,000 for data backup.” Prompt 200 is shown next to a circle with the letter “Q” inside the circle to indicate a question from the customer that was submitted via chat window 222.

Output 224 may include the following text: “The proposed system design includes Server A that will host large language model (LLM) B fine-tuned on the data stored in the ten databases. Storage system C will be used for backup with configuration D. The cost of the system is $195,000 for training and $237,000 for backup.” Output 224 is shown next to a circle with the letter “A” inside the circle to indicate an answer from the manufacturer/vendor for the product (e.g., via the generative AI model). Output 224 may be visible to the customer via chat window 222.

To provide variability information to the downstream consumer, prompt 200 may be iteratively perturbated (e.g., modified) as described in prompt perturbation process 204 in FIG. 2A. The perturbated prompts may be fed into the generative AI model (e.g., 202) to obtain perturbated outputs as described in output generation process 208 in FIG. 2A to obtain a set of aligned sequences.

Turning to FIG. 2C, an example of a set of aligned sequences (e.g., aligned sequences 230) is shown. Aligned sequences 230 may include portions of three perturbated outputs based on perturbations to prompt 200. Words, phrases, punctuation marks, and/or other elements of the perturbated outputs may be identified as tokens (e.g., token 232) in each of the perturbated outputs.

An alignment process may be performed (e.g., output alignment process 212 described in FIG. 2A) using the three perturbated outputs to increase alignment between the tokens of each of the perturbated outputs. In FIG. 2C, for example, spaces have been inserted (e.g., shown as dashes) between tokens of some of the perturbated outputs to increase alignment between corresponding tokens.

Token 232, token 234, and token 236 may be corresponding tokens (e.g., may be determined via an algorithm or mathematical formulation to be prices associated with training). Therefore, tokens 232, 234, and 236 have been aligned vertically to indicate that the tokens are related. Aligned sequences 230 may be generated relative to one of the perturbated outputs. For example, the first perturbated output (e.g., including token 232) may be the reference output and the other perturbated outputs (e.g., including token 234 and token 236) may be aligned relative to the first output.

Aligned sequences 230 may be used to generate differences between corresponding tokens (e.g., a difference between token 232 and 234, a difference between token 232 and 236). Refer to FIG. 2D for an example of generating differences between tokens.

Turning to FIG. 2D, an example of differences between corresponding tokens of aligned sequences 230 is shown. Aligned tokens 240 shows token 232, token 234, and token 236 from aligned sequences 230. Differences 242 may be generated based on aligned tokens 240. Token 232 may be part of the first sequence of aligned sequences 230 shown in FIG. 2C and, therefore, differences 242 may be generated relative to token 232.

For example, differences 242 may include a first difference between token 232 and token 234 (e.g., $55,000) and a second difference between token 232 and token 236 (e.g., $95,000). In FIG. 2D, differences 242 are based on numerical values of aligned tokens 240 (e.g., by subtracting corresponding tokens). However, differences between tokens may be generated via other methods without departing from embodiments disclosed herein. Refer to FIG. 2A for additional details regarding calculating differences.

Turning to FIG. 2E, an example of displaying variability information to a user via graphical user interface (GUI) 220 is shown. In FIG. 2E, four portions of output 224 are highlighted with different degrees of shading. The different degrees of shading may indicate degrees of variability for the highlighted portions.

“Server A” may be highlighted with a first degree of shading (e.g., a lightest degree of shading) to indicate a low degree of variability. “Large language model (LLM) B” and “$237,000” may be highlighted with a second degree of shading (e.g., a medium degree of shading) to indicate a medium degree of variability. “$195,000” may be highlighted with a third degree of shading (e.g., a high degree of shading) to indicate a high degree of variability. The low, medium, and high degrees of variability may be relative to one another, may be based on a schema that bucketizes degrees of variability into “low,” “medium,” and “high,” and/or may be assigned based on any other method.

Degrees of variability may be represented via other methods (e.g., a color-coded heat map) without departing from embodiments disclosed herein.

The user may interact with GUI 220 by selecting one of the highlighted portions. For example, the user may select the portion “$195,000” as shown in FIG. 2E and variability information 250 for portion “$195,000” may be displayed as a pop-up window on GUI 220.

Variability information 250 may include any number of aggregated statistics related to the selected portion. For example, variability for the selected portion may be considered “high” based on a bucketized range of “>70% variability.” The variability of “>70%” may be calculated via any method (e.g., a percent difference). In addition, a “breakdown” of the variability of the selected portion may be shown in variability information 250. The “breakdown” may include: (i) a range over which values for the selected portion varied across other perturbated outputs, (ii) a mean of the different values for the selected portion across the perturbated outputs, (iii) a standard deviation for the different values for the selected portion across the perturbated outputs, and/or (iv) other aggregated statistics. Variability information 250 may include less, more, and/or different types of variability-related statistical information without departing from embodiments disclosed herein.

Variability information 250 may be used by the user to better understand a stability of the selected portion of output 224. For example, the high variability of the selected portion may indicate that the cost of the system for training has a low stability relative to other portions of output 224 (e.g., the cost of training changes to a degree considered high with modifications to the prompt).

While shown with respect to having four highlighted portions, any number of portions of output 224 may be selectable and/or highlighted without departing from embodiments disclosed herein. The portions of output 224 (and/or portions of other perturbated outputs) may be displayed to the user and may be selectable in other ways without departing from embodiments disclosed herein.

As discussed above, the components of FIG. 1 may perform various methods to manage a data processing system. FIG. 3 illustrates methods that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of providing computer-implemented services using generative AI models in accordance with an embodiment is shown. The method may be performed, for example, by any of the components of the system of FIG. 1, and/or other components not shown therein.

At operation 300, a prompt may be obtained for a first generative AI model of generative AI models. Obtaining the prompt for the first generative AI model may include: (i) reading the prompt from storage, (ii) receiving (e.g., via a communication system) the prompt from another entity, (iii) receiving the prompt as part of user feedback submitted via a GUI (e.g., a chat interface displayed on the user's device), and/or (iv) other methods.

At operation 302, the prompt may be iteratively perturbated to obtain perturbated prompts. Iteratively perturbating the prompt may include: (i) during a first perturbation, removing a first information element (e.g., a first token) of the prompt obtain a first perturbated prompt, (ii) during a second perturbation, removing a second information element of the prompt to obtain a second perturbated prompt, and/or (iii) other methods. Iteratively perturbating the prompt may include any number of perturbations to obtain any number of perturbated prompts.

Iteratively perturbating the prompt may also include: (i) replacing the first information element with a first replacement information element to obtain a third perturbated prompt, (ii) replacing the first information element with a second replacement information element to obtain a fourth perturbated prompt, and/or (iii) other methods.

Removing the first information element may include: (i) selecting the first information element (e.g., randomly, based on a schema, based on feedback from a downstream consumer, based on feedback from a subject matter expert), (ii) deleting the first information element from the prompt, (iii) using a model (e.g., a second generative AI model) to create the first perturbated prompt, and/or (iv) other methods.

Replacing the first information element with the replacement information element may include: (i) deleting the first information element from the prompt, (ii) adding the replacement information element to the prompt, (iii) providing the replacement information element and the prompt to another entity responsible for replacing the first information element, and/or (iv) other methods.

If the at least one action performed as part of iteratively perturbating the prompt includes replacing the first information element with a replacement information element, the replacement information element may be obtained prior to replacing the first information element.

Obtaining the replacement information element may include: (i) obtaining an information element replacement schema (e.g., from storage, from another entity via a communication system, from a downstream consumer via a GUI), (ii) reading instructions from the information element replacement schema (e.g., for selecting the first information element, for obtaining the replacement information element), (iii) selecting, based on the information element replacement schema, the first information element, (iv) performing a search process (e.g., a lookup process, a RAG process) using the first information element to obtain one or more replacement information elements (e.g., from a database, from another entity, from any number of other data sources), and/or (v) other methods.

At operation 304, the first generative AI model and the perturbated prompts may be used to obtain perturbated outputs. Using the first generative AI model and the perturbated prompts to obtain the perturbated outputs may include: (i) feeding perturbated prompts (e.g., as is, following data processing such as a RAG process) into the first generative AI model to obtain the plurality of the outputs from an output layer of the first generative AI model, (ii) providing the perturbated prompts to another entity responsible for operating the first generative AI model, and/or (iii) other methods.

At operation 306, an output alignment process may be performed using the perturbated outputs to obtain differences between portions of the perturbated outputs. Performing the output alignment process may include: (i) obtaining a first sequence of tokens corresponding to a first perturbated output of the perturbated outputs, (ii) aligning the first sequence of the tokens to other sequences of tokens corresponding to other perturbated outputs of the perturbated outputs to obtain a first set of aligned sequences, (iii) for each token of the first sequence of the tokens, comparing the token to corresponding tokens of the first set of the aligned sequences to generate a sub-set of the differences corresponding to the tokens of the first sequence of the tokens, and/or (iv) other methods.

Obtaining the first sequence of tokens may include: (i) reading the first sequence of tokens from storage, (ii) receiving the first sequence of tokens from another entity (e.g., via a communication system, via an application programming interface (API)), (iii) generating the first sequence of tokens using a generative AI model (e.g., extracting tokens of the first sequence of the tokens from text using natural language processing and/or other methods), and/or (iv) other methods.

Aligning the first sequence of the tokens to the other sequences of the tokens may include: (i) shifting, using a mathematical formulation, the other sequences relative to the first sequence to increase alignment between tokens of the first sequence and tokens of the other sequences, (ii) providing the first sequence and the other sequences to another entity and receiving the first set of aligned sequences from the entity, and/or (iii) other methods.

Shifting the other sequences relative to the first sequence may include: (i) performing any alignment algorithm (e.g., dynamic programming, progressive alignment construction, iterative methods, consensus methods) using the first sequence and the other sequences, (ii) providing the first sequence and the other sequences to another entity responsible for executing the algorithm, and/or (iii) other methods.

Comparing the token (e.g., a first token of the first sequence) to the corresponding tokens of the first set of the aligned sequences may include: (i) computing a difference (e.g., refer to FIG. 2A for examples of types of differences) between the first token and each of the corresponding tokens, (ii) feeding the token and the corresponding tokens into an inference model trained to generate the differences, and/or (iii) other methods. Differences may be obtained for each token of the first sequence using corresponding tokens from the other sequences.

At operation 308, degrees of variability for the portions of the perturbated outputs may be obtained using the differences. Obtaining the degrees of variability may include: (i) reading the degrees of variability from storage, (ii) providing the differences to another entity and receiving the degrees of variability from the entity in response, (iii) generating the degrees of variability (e.g., computing any number of aggregated statistics for each token of the first sequence using the differences), and/or (iv) other methods.

At operation 310, computer-implemented services may be provided to a downstream consumer using at least the degrees of variability. Providing the computer-implemented services to the downstream consumer may include: (i) populating, using at least the first perturbated output and degrees of variability corresponding to tokens of the first perturbated output, a GUI to obtain a populated GUI, (ii) making decisions based on at least the degrees of variability, (iii) providing the perturbated output, the degrees of variability, and/or other information to another entity (e.g., the downstream consumer), and/or (iv) other methods.

Populating the GUI with at least the first perturbated output and the degrees of variability may include: (i) uploading, via an application programming interface (API), the first perturbated output and the degrees of variability to the GUI, (ii) providing the first perturbated output and the degrees of variability to another entity responsible for uploading the first perturbated output and the degrees of variability to the GUI, and/or (iii) other methods.

The GUI may display, to the downstream consumer, portions of a selected perturbated output of the perturbated outputs (e.g., the downstream consumer may select a perturbated output). The portions of the selected perturbated output may be color-coded (e.g., with different colors, with different shading) based on the degrees of variability for the portions of the perturbated output. Refer to FIG. 2E for an example of different degrees of shading indicating different degrees of variability for portions of a perturbated output.

The method may end following operation 310.

Thus, as illustrated above, embodiments disclosed herein may provide systems and methods usable to provide computer-implemented services using generative AI models. By providing degrees of variability to a downstream consumer along with an output generated by the generative AI model in response to a prompt, a likelihood of the output meeting needs of the downstream consumer may be increased.

Any of the components illustrated in FIGS. 1-2E may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using generative artificial intelligence (AI) models, the method comprising:
obtaining a prompt for a first generative AI model of the generative AI models;
iteratively perturbating the prompt to obtain perturbated prompts;
using the first generative AI model and the perturbated prompts to obtain perturbated outputs;
performing, using the perturbated outputs, an output alignment process to obtain differences between portions of the perturbated outputs;
obtaining, using the differences, degrees of variability for the portions of the perturbated outputs; and
providing computer-implemented services to a downstream consumer using at least the degrees of variability.

2. The method of claim 1, wherein performing the output alignment process comprises:
for a first perturbated output of the perturbated outputs:
obtaining a first sequence of tokens corresponding to the first perturbated output;
aligning the first sequence of the tokens to other sequences of tokens corresponding to other perturbated outputs of the perturbated outputs to obtain a first set of aligned sequences; and
for each token of the first sequence of the tokens, comparing the token to corresponding tokens of the first set of the aligned sequences to generate a sub-set of the differences corresponding to the tokens of the first sequence of the tokens.

3. The method of claim 2, wherein aligning the first sequence of the tokens comprises:
shifting, using a mathematical formulation, the other sequences relative to the first sequence to increase alignment between tokens of the first sequence and tokens of the other sequences.

4. The method of claim 2, wherein a degree of variability of the degrees of variability is based on at least one measure of variability selected from a list of types of measures of variability consisting of:
a range of differences of the sub-set of the differences corresponding to a first token of the first sequence of the tokens,
a standard deviation for the differences corresponding to the first token, and
a variance for the differences corresponding to the first token.

5. The method of claim 1, wherein the portions of the perturbated outputs comprise tokens generated by the first generative AI model.

6. The method of claim 3, wherein a token of the tokens comprises at least one type of token selected from a list of types of tokens consisting of:
a word;
a letter;
a punctuation mark; and
a phrase.

7. The method of claim 1, wherein providing the computer-implemented services comprises:
populating, using at least a first perturbated output of the perturbated outputs and the degrees of variability corresponding to tokens of the first perturbated output, a graphical user interface (GUI) to obtain a populated GUI, the populated GUI being viewable by the downstream consumer.

8. The method of claim 7, wherein the GUI displays, to the downstream consumer, portions of a selected perturbated output of the perturbated outputs and the portions of the selected perturbated output are color-coded based on the degrees of variability for the portions of the selected perturbated output.

9. The method of claim 1, wherein iteratively perturbating the prompt comprises:
obtaining first tokens of the prompt; and
performing at least one action selected from a list of actions consisting of:
removing a first token of the first tokens to obtain a first perturbated prompt of the perturbated prompts; and
replacing the first token with a replacement token to obtain the first perturbated prompt.

10. The method of claim 1, wherein the first generative AI model is a large language model (LLM).

11. A non-transitory machine-readable medium having instructions stored therein, which when executed by a processor, cause the processor to perform operations for providing computer-implemented services using generative artificial intelligence (AI) models, the operations comprising:
obtaining a prompt for a first generative AI model of the generative AI models;
iteratively perturbating the prompt to obtain perturbated prompts;
using the first generative AI model and the perturbated prompts to obtain perturbated outputs;
performing, using the perturbated outputs, an output alignment process to obtain differences between portions of the perturbated outputs;
obtaining, using the differences, degrees of variability for the portions of the perturbated outputs; and
providing computer-implemented services to a downstream consumer using at least the degrees of variability.

12. The non-transitory machine-readable medium of claim 11, wherein performing the output alignment process comprises:
for a first perturbated output of the perturbated outputs:
obtaining a first sequence of tokens corresponding to the first perturbated output;
aligning the first sequence of the tokens to other sequences of tokens corresponding to other perturbated outputs of the perturbated outputs to obtain a first set of aligned sequences; and
for each token of the first sequence of the tokens, comparing the token to corresponding tokens of the first set of the aligned sequences to generate a sub-set of the differences corresponding to the tokens of the first sequence of the tokens.

13. The non-transitory machine-readable medium of claim 12, wherein aligning the first sequence of the tokens comprises:
shifting, using a mathematical formulation, the other sequences relative to the first sequence to increase alignment between tokens of the first sequence and tokens of the other sequences.

14. The non-transitory machine-readable medium of claim 12, wherein a degree of variability of the degrees of variability is based on at least one measure of variability selected from a list of types of measures of variability consisting of:
a range of differences of the sub-set of the differences corresponding to a first token of the first sequence of the tokens,
a standard deviation for the differences corresponding to the first token, and
a variance for the differences corresponding to the first token.

15. The non-transitory machine-readable medium of claim 11, wherein the portions of the perturbated outputs comprise tokens generated by the first generative AI model.

16. A data processing system, comprising:
a processor; and
a memory coupled to the processor to store instructions, which when executed by the processor, cause the processor to perform operations for providing computer-implemented services using generative artificial intelligence (AI) models, the operations comprising:
obtaining a prompt for a first generative AI model of the generative AI models;
iteratively perturbating the prompt to obtain perturbated prompts;
using the first generative AI model and the perturbated prompts to obtain perturbated outputs;
performing, using the perturbated outputs, an output alignment process to obtain differences between portions of the perturbated outputs;
obtaining, using the differences, degrees of variability for the portions of the perturbated outputs; and
providing computer-implemented services to a downstream consumer using at least the degrees of variability.

17. The data processing system of claim 16, wherein performing the output alignment process comprises:
for a first perturbated output of the perturbated outputs:
obtaining a first sequence of tokens corresponding to the first perturbated output;
aligning the first sequence of the tokens to other sequences of tokens corresponding to other perturbated outputs of the perturbated outputs to obtain a first set of aligned sequences; and
for each token of the first sequence of the tokens, comparing the token to corresponding tokens of the first set of the aligned sequences to generate a sub-set of the differences corresponding to the tokens of the first sequence of the tokens.

18. The data processing system of claim 17, wherein aligning the first sequence of the tokens comprises:
shifting, using a mathematical formulation, the other sequences relative to the first sequence to increase alignment between tokens of the first sequence and tokens of the other sequences.

19. The data processing system of claim 17, wherein a degree of variability of the degrees of variability is based on at least one measure of variability selected from a list of types of measures of variability consisting of:
a range of differences of the sub-set of the differences corresponding to a first token of the first sequence of the tokens,
a standard deviation for the differences corresponding to the first token, and
a variance for the differences corresponding to the first token.

20. The data processing system of claim 16, wherein the portions of the perturbated outputs comprise tokens generated by the first generative AI model.
